(19) United States
(12) Patent Application Publication
(10) Pub. No.: US 2017/0011554 A1
(43) Pub. Date: Jan. 12, 2017

(54) SYSTEMS AND METHODS FOR DYNAMIC SPECTATING

(71) Applicant: Survios, Inc., Culver City, CA (US)

(72) Inventors: Nathan Burba, Los Angeles, CA (US); James IIiff, Culver City, CA (US)

(21) Appl. No.: 15/199,375

(22) Filed: Jun. 30, 2016

Related U.S. Application Data
(60) Provisional application No. 62/187,597, filed on Jul. 1, 2015.

(51) Int. Cl. G06T 19/00; G06F 3/14

(52) U.S. Cl. CPC G06T 19/003; G06F 3/1423; G06T 19/006; G06T 2219/024

(57) ABSTRACT

A system for dynamic spectating includes a first virtual environment display that displays a first perspective of a virtual environment to a spectator; a status overlay that displays information about an event occurring within the virtual environment; and a virtual camera manager that controls the position and orientation of the first perspective within the virtual environment.

### CROSS-REFERENCE TO RELATED APPLICATIONS

This application claims the benefit of U.S. Provisional Application No. 62/187,597, filed 1 Jul. 2015, which is incorporated in its entirety by this reference.

### TECHNICAL FIELD

This invention relates generally to the virtual reality field, and more specifically to new and useful systems and methods for dynamic spectating.

### BACKGROUND

If asked to name the top sporting events (by viewership) of 2014, most people might correctly guess the Super Bowl, NBA Finals, and MLB World Series. But how about the 2014 League of Legends championship? At 27 million viewers, spectatorship for this video game competition topped both Game 7 of the World Series (23.5 m) and the final victory of the Spurs over the Heat (18 m).

This is no isolated incident. The video game streaming site Twitch has grown to an audience of 51 million worldwide, delivering more than 26 billion minutes of content per month—making it bigger than 70% of American television networks. Put simply, the next big thing in event broadcasting has arrived.

The dream of popularizing video game spectatorship has existed for decades (e.g., the 1990 Nintendo World Championships), but it is only recently that conditions within the video game industry and broadcast technology have aligned in the manner required for the success of companies like Twitch.

While video games have been a big contributor to the evolution of entertainment over the past two decades, the next step in entertainment evolution is in sight: virtual and augmented reality. On this new frontier, spectatorship will be just as important—but its implementation will bring both new challenges and new opportunities. Thus, there exists a need in the virtual reality field to create new and useful systems and methods for systems and methods for dynamic spectating. This invention provides such new and useful systems and methods.

### BRIEF DESCRIPTION OF THE FIGURES

FIG. 1 is a schematic representation of a system of a preferred embodiment;

FIG. 2 is an example representation of a status overlay of a system of a preferred embodiment;

FIG. 3 is an example representation of a virtual camera manager of a system of a preferred embodiment; and

FIG. 4 is an example representation of an avatar facial overlay process.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

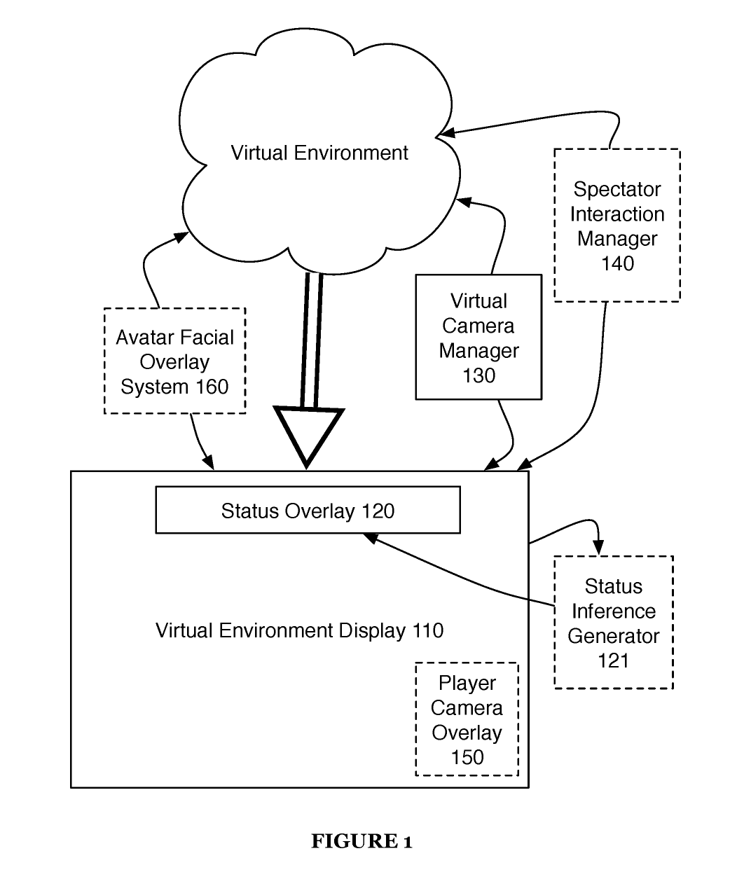

A system 100 for dynamic spectating includes a virtual environment display 110, a status overlay 120, a virtual camera manager 130, and an environment interaction manager 140, as shown in FIG. 1. The system 100 may additionally or alternatively include a player camera overlay 150 and/or an avatar facial overlay system 160.

The system 100 functions to enable a dynamic spectating experience for virtual environment spectators; allowing spectators to view virtual environments from multiple perspectives, and potentially even enabling interaction with the virtual environment. The system 100 preferably displays one or more perspectives of the virtual environment to spectators through the virtual environment display 110, which may be overlaid with environment/event status information (via the status overlay 120), camera data of environment participants (via the player camera overlay 150, and/or any other data. The perspectives shown in the virtual environment display are preferably managed by the virtual camera manager 130, and spectator interaction with the virtual environment is preferably controlled by the spectator interaction manager 140.

The system 100 is preferably used with a natural motion virtual reality computing system (e.g., as described in U.S. Provisional Patent Applications Nos. 62/164,329 and 62/194,626, the entireties of which are incorporated by this reference), but may additionally or alternatively be used with any system capable of generating a 3D virtual environment (e.g., a video game console).

The virtual environment display 110 functions to display one or more perspectives of a virtual environment to a spectator of that environment. The perspective displayed by the virtual environment display 110 is preferably controllable by the spectator, but may additionally or alternatively be only partially controllable (or not controllable at all) by the spectator.

The virtual environment display 110 preferably displays a single perspective at a time to a spectator, but may additionally or alternatively display multiple perspectives at a time to a spectator (e.g., via picture-in-picture inset overlay).

Examples of perspectives that may be displayed by the virtual environment display 110 include first-person perspectives (e.g., the view a player in a virtual environment might see), third-person perspectives (e.g., such as a virtual camera positioned behind a player's avatar (i.e., a graphical representation of a player-controlled character) and fixed in position and/or orientation to that player), and free perspectives (user is not locked to any particular object or player). Additionally or alternatively, perspectives may be fixed/referenced to any object or aspect of the virtual environment.

Perspectives displayed by the virtual environment display 110 may be partially constrained, fully constrained, and/or unconstrained. In a first example, a perspective mode allows a spectator to observe a virtual environment from any position and orientation (including inside walls). In a second example, a perspective mode allows a spectator to observe a virtual environment from any position and orientation except for spaces inaccessible to players (e.g., spectators cannot set position to inside a solid object). In a third example, a perspective mode allows a spectator to observe a virtual environment from the third person perspective of a player's avatar, within a set distance range (e.g., the spectator may choose any orientation with an optical path intersecting the avatar for a set range of radii). In a fourth example, a perspective mode allows a spectator to observe a virtual environment from the third person perspective of a player's avatar, within a set rotational range (e.g., the spectator may look up to thirty degrees left/right of a player's sightline). In a fifth example, a perspective mode allows a spectator to observe a virtual environment from the first person perspective of a player's avatar.

Perspective modes may be controlled in any manner; for example, if perspectives are locked to particular avatars, spectators may be able to select which avatar they would like to observe. As another example, if a perspective mode is not locked to a particular reference point, spectators may control the position of the perspective (e.g., flying around a virtual environment).

In some cases, spectator perspective may be subject to virtual environment physics. For example, a spectator may have to navigate a virtual environment in the same way a virtual environment user might (as opposed to flying around the environment unconstrained by gravity). For example, a spectator may have a ‘spectator’ avatar (which may or may not be visible) that may be subject to the same physics rules as a player avatar. In this example, the spectator avatar may have limited ability to interact with the virtual environment; for example, the spectator avatar may move in similar ways to player avatars but may be invisible to player avatars, may interact only with a subset of the objects a player avatar may interact with (or none at all), and/or may be able to occupy the same space as a player avatar (this may be an exception to physics engine constraints).

As another example, a spectator perspective may simply be bound by certain rules (e.g., no clipping of walls).

The virtual environment display 110 preferably displays virtual environment perspectives as a two-dimensional ‘window’ into a virtual environment, but may additionally or alternatively display virtual environments in any manner (e.g., in a fully three-dimensional manner using a head-mounted display, in a panoramic two-dimensional representation, etc.).

The virtual environment display 110 may display a real-time virtual environment, but may additionally or alternatively display a previously-existing virtual environment state. For example, the virtual environment display 110 may be used after completion of a virtual game match to produce highlights or to analyze game strategy.

If the virtual environment display 110 is not in real-time, the virtual environment display 110 may include temporal controls (e.g., changing playback speed of changing virtual environment display, pausing, stopping, etc.).

The virtual environment display 110 is preferably controlled directly by spectators but may additionally or alternatively be controlled by third parties. For example, a virtual environment spectation system may have an administrator that directs what spectators are viewing through the virtual environment display 110.

The virtual environment display 110 preferably includes a user interface that allows selection of perspective and/or other configuration options, but may additionally or alternatively allow configuration in any manner.

In a variation of a preferred embodiment, the virtual environment display 110 is configured to stream virtual environment data to others (or for another similar purpose). In this variation, the virtual environment display 110 may include multiple user interfaces; e.g., a first user interface displayed to the controller of the stream (i.e., the primary ‘spectator’) and a second user interface displayed to people watching the stream.

In this manner, the ‘primary spectator’ may be able to curate, collect, modify, and/or aggregate virtual environment visual data to produce a spectator feed.

The ‘primary spectator’ may alternatively be referred to as a ‘spectation administrator’, although the spectation administrator may additionally or alternatively be a player in the virtual environment or any other entity. For example, a player of the virtual environment may have certain controls (e.g., in the virtual camera manager 130) that enable a first perspective to be shown to the player (e.g., a first-person 3D interface) while a second selectable interface may be shown to spectators (e.g., a third-person 2D perspective that follows the player).

Perspectives displayed by the virtual environment display 110 are preferably controlled by the virtual camera manager 130, but may additionally or alternatively be controlled in any manner (e.g., manually by a spectator).

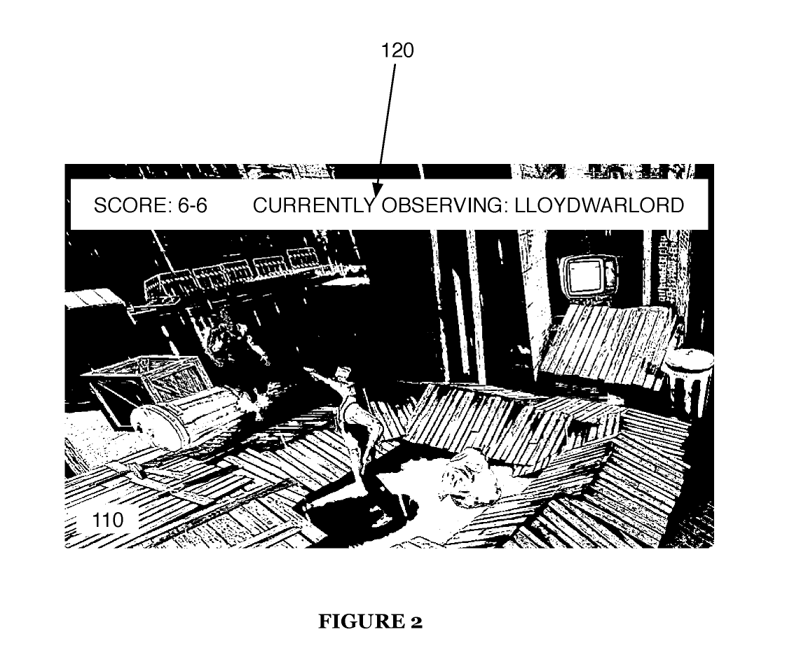

The status overlay 120 functions to provide information about the virtual environment, events occurring within the virtual environment, and/or any other data relevant to spectators, as shown in FIG. 2. For example, a status overlay 120 for a team-based first person shooter game may display a map of the play arena, a score display (including score count and time remaining the round), a team status display (e.g., which team members are alive and which are dead), and, for a player being observed: that player's name, health, stamina, ammo, weapons, etc.

The status overlay 120 may additionally or alternatively display other data; for example, a status overlay 120 may display status information from other virtual environments (e.g., during a game tournament, the scores of other games being played). As another example, the status overlay 120 may display information intended for spectators but not directly related to virtual environments (e.g., advertisements, a chat window, etc.).

The status overlay 120 may be static (i.e., displaying the same information types over time) or dynamic (i.e., displaying changing information types over time). For example, a dynamic status overlay 120 may include an area that cycles between displaying scores from other games and advertisements.

The status overlay 120 is preferably set by virtual environment administrators, but may additionally or alternatively be set in any manner. For example, the virtual environment may include a spectation API that allows spectators to program or use custom interfaces displaying virtual environment data.

In a variation of a preferred embodiment, the status overlay 120 displays inferred information; that is, information not explicitly made available by the virtual environment API (or database, etc.) but instead inferred from other virtual environment data. For example, the system 100 may run pattern matching software that scans the virtual environment display 110 for a particular avatar; when that avatar is detected, the status overlay 120 may highlight the avatar.

To accomplish this, the system 100 may include a status inference generator 121 that processes visual data received from the virtual environment (either pre or post-render). This visual data may be collected directly from the virtual environment display 110 (e.g., the one shown to a spectator), from a player view, or from any other source of virtual environment video data.

The status inference generator 121 may perform inference or recognition using one or more of: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and any other suitable learning style. Each module of the plurality can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, boostrapped aggregation, AdaBoost, stacked generalization, gradient boosting machine method, random forest method, etc.), and any suitable form of machine learning algorithm. However, any suitable machine learning approach (or any suitable model) can be utilized by the status inference generator 121.

The status overlay 120 may also display information relevant to control of the spectation environment. For example, the status overlay 120 may include a display indicating the current perspective mode (e.g., locked third-person, free, etc.).

The virtual camera manager 130 functions to control virtual environment viewing perspectives. The virtual camera manager 130 preferably is used to control the perspective displayed in the virtual environment display 110, but may additionally or alternatively be used to control perspectives of any virtual environment capture. For example, the virtual camera manager 130 may record image data from a perspective (but may not display that perspective in the virtual environment display 110). This could be useful, for instance, to make films using virtual environment detail.

The virtual camera manager 130 is preferably used to cycle through or otherwise select designated perspective modes, but may additionally alternatively serve to designate new perspective modes. For example, a spectator may chose a position and orientation for a virtual camera and add that perspective/orientation to the virtual camera manager 130 as a virtual camera. In some cases, a spectator may additionally or alternatively configure virtual camera parameters (e.g., focal length, field of view, autofocusing, brightness/contrast, etc.).

Spectators preferably select virtual environment perspectives for display (on virtual environment display 110) or recording using a virtual camera manager interface. The virtual camera manager interface is preferably overlaid on the virtual environment display 110, but may additionally or alternatively be accessed in any manner.

If the system 100 is used to stream spectation data to others, the virtual camera manager 130 preferably appears only to spectators with perspective control (e.g., the spectation administrator). Additionally or alternatively, the virtual camera manager 130 may appear in any form to any viewers.

As mentioned in the section on the virtual environment display 110, the spectation administrator may be displayed an interface distinct from the interface displayed to other spectators; for example, the interface shown to a spectation administrator may feature a set of virtual camera manager 130 controls.

A spectation administrator may manage other spectator's virtual environment displays 110 in any manner. For example, a spectation administrator may specify which virtual environment perspective(s) are displayed to other spectators. In one example embodiment, a spectation administrator may select a player to ‘follow’; that is, a dynamic perspective that follows the avatar of a virtual environment player. The spectation administrator may select this dynamic perspective in any manner (e.g., by selecting a player name or a graphic representing a player).

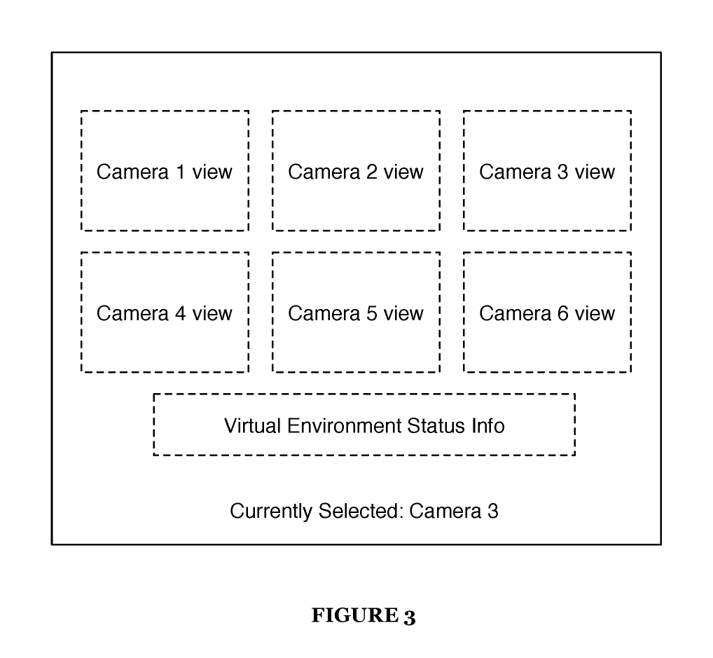

In one example embodiment, the virtual camera manager 130 may allow viewing of multiple virtual camera perspectives simultaneously, as shown in FIG. 3. In this example embodiment, a spectator could select virtual camera perspectives to be displayed to stream viewers, similarly to how sports broadcast producers may view and switch between multiple camera angles.

The virtual camera manager 130 preferably indicates to users (e.g., spectation administrators) which virtual camera perspective(s) are selected. For example, the virtual camera manager 130 may highlight the edges of a virtual camera perspective inset to indicate that that perspective is selected. Additionally or alternatively, the virtual camera manager 130 may indicate selected perspectives in any manner.

The virtual camera manager 130 may additionally or alternatively be used to determine what aspects of a virtual environment are captured and/or displayed. For example, a virtual environment may allow player image ‘sprays’ (e.g., players may project an image of their choice onto a surface within the virtual environment); the virtual camera manager may allow these sprays to either be visible or invisible to the virtual camera. As another example, a virtual camera manager 130 may direct a virtual camera to capture image data (e.g., post-rendering) and/or virtual environment data (e.g., environment state pre-rendering). This may be of use to virtual filmmakers; allowing scenes to be ‘filmed’ at a low render quality (enabling real-time manipulation) and later re-rendered at a much higher quality.

The virtual camera manager 130 may be used with temporal controls if present; for example, a spectator could navigate through virtual environment state (e.g., step through time) and record clips at various times through the virtual camera manager 130.

The virtual camera manager 130 may additionally or alternatively include automation and/or scripting ability (e.g., a spectator could specify that a particular virtual camera pan at a particular time, etc.).

The virtual camera manager 130 preferably allows for selection of visual information, but may additionally or alternatively allow for selection of audio or other information as well. For example, the virtual camera manager 130 may allow spectators to select audio feeds to be played for a given camera feed. Audio feeds may be a single feed (e.g., game sounds localized to a particular camera) or may be multiple feeds (e.g., in the case of spectation, a combined audio feed of game sounds, player voice feeds, and commentator voice feeds).

The virtual camera manager 130 may enable management of audio feeds; additionally or alternatively, audio feeds may be managed in any other manner.

In one implementation of a preferred embodiment, virtual cameras are represented within the virtual environment (e.g., are displayed in some manner in the virtual environment). The virtual cameras may be visible to all spectators and all virtual environment users, but may additionally or alternatively be visible to only a subset of potential viewers. For example, the virtual cameras may be invisible to spectators but may be visible to in-game players (enabling players to hide from cameras, or to position themselves relative to cameras, etc.).

If virtual cameras are represented within the virtual environment, they may additionally or alternatively be modified through the virtual environment. For example, if a player shoots a virtual camera that camera may no longer be able to provide a viewing perspective. As another example, players may manipulate cameras (e.g., rotate or reposition a camera).

Virtual camera feedback may be displayable within the virtual environment as well. For example, players within the game may be able to see virtual camera feeds on virtual screens within the virtual environment.

The environment interaction manager 140 functions to enable spectators to interact with the virtual environment. The environment interaction manager 140 preferably allows spectators to interact with the virtual environment in a limited manner. Some examples include displaying spectators with visible avatars (e.g., players can see spectators), and allowing spectators to modify virtual environments (e.g., changing weather in a virtual world, repositioning objects, etc.). As another example, a spectator may be able to place indicators in the virtual environment (e.g., a flat arrow painted on a virtual surface, a 3D arrow floating in-game). This may be useful to provide direction to players; for example, a spectator may serve as a ‘director’ while players serve as ‘actors’—the director may place visual cues to direct players on where to stand, etc.

The environment interaction manager 140 may additionally or alternatively enable communication between spectators and players; for example, spectators may speak to players through a virtual speaker in-game, or may display information to players via in-game virtual displays.

The virtual speaker may be localized to a particular location (analogous to how a real speaker operates) but may additionally or alternatively be represented as a disembodied voice (that may or may not be localized to a particular position).

If the virtual speaker is localized, that localization may be static (e.g., a coordinate on a map) or dynamic (e.g., a moving player).

The player camera overlay 150 preferably functions to display real-world images of players on top of virtual environment feeds. Additionally or alternatively, the player camera overlay 150 may display real-world images of players in any manner. For example, the player camera overlay 150 may display a feed of a camera trained on a player's face; the player displayed is the player whose perspective the spectator is currently viewing. For multiple players and/or multiple player camera perspectives, the player camera overlay 150 may enable selection and/or display of these perspectives in any manner.

The system 100 may additionally or alternatively include any other suitable overlays (e.g., a text chat overlay that allows spectators to communicate with each other).

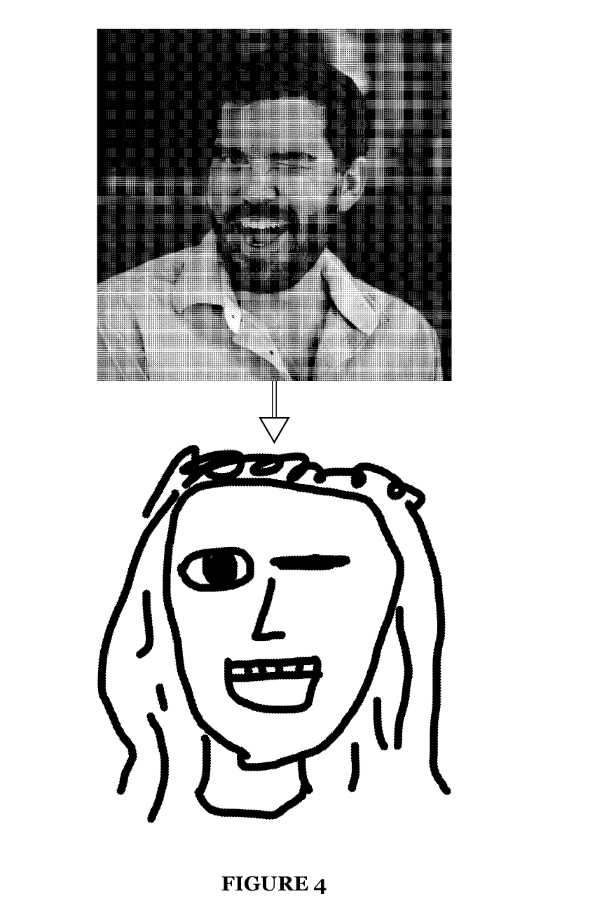

The avatar facial overlay system 160 functions to overlay mouth and eye tracking data onto avatars, as shown in FIG. 4. The avatar facial overlay system 160 preferably takes real-world video feeds of players (and/or spectators) and uses this data to generate player mouth and/or eye movement data. This data is preferably converted using a model into facial movements of an avatar in-game. In some embodiments, this real-world video may be the same real-world video used to produce the player camera overlay 150.

Player facial movement data may be captured in any suitable manner; in one example, eye-tracking data is captured by cameras mounted to the interior of a head-mounted display.

The avatar facial overlay system 160 may additionally or alternatively simulate player (and/or spectator) facial movement data based on other data. For example, the avatar facial overlay system may estimate mouth position based on an audio feed (e.g., the output of a player's microphone).

Output of the avatar facial overlay system 160 is preferably controlled by the spectator, but may additionally or alternatively be controlled in any manner. For example, a spectator may designate that avatar facial overlay be calculated in different manners for real-time (less precise, but faster) data than for visual data that can be rendered later (more precise, but too slow for real-time).

The methods of the preferred embodiment and variations thereof can be embodied and/or implemented at least in part as a machine configured to receive a computer-readable medium storing computer-readable instructions. The instructions are preferably executed by computer-executable components preferably integrated with a virtual environment spectation system. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

As a person skilled in the art will recognize from the previous detailed description and from the figures and claims, modifications and changes can be made to the preferred embodiments of the invention without departing from the scope of this invention defined in the following claims.

We claim:

1. A system for dynamic spectating includes:
a first virtual environment display that displays a first perspective of a virtual environment to a spectator;
a status overlay that displays information about an event occurring within the virtual environment; and
a virtual camera manager that controls the position and orientation of the first perspective within the virtual environment.

2. The system of claim 1, wherein the virtual camera manager is accessible only to a spectator administrator; wherein the spectator administrator is an entity distinct from the spectator.

3. The system of claim 2, further comprising a second virtual environment display, distinct from the first virtual environment display, that displays both of the first perspective of the virtual environment and a set of virtual camera manager controls to the spectator administrator.

4. The system of claim 3, wherein the second virtual environment display displays a second perspective of the virtual environment simultaneous with the first perspective, the second perspective distinct from the first perspective, and enables selection, by the spectation administrator, of the first perspective or the second perspective as a selected perspective; wherein the selected perspective is displayed to the spectator; wherein the second virtual environment display indicates the selected perspective to the spectation administrator.

5. The system of claim 4, wherein the second virtual environment display enables the spectation administrator to select a dynamic perspective as the selected perspective; wherein the dynamic perspective follows a player in the virtual environment and is modified in response to movement of the player within the virtual environment.

6. The system of claim 5, wherein the second virtual environment display enables the spectation administrator to select the dynamic perspective by selecting a name of the player.

7. The system of claim 5, wherein the second virtual environment display enables the spectation administrator to select the dynamic perspective by selecting a graphic representing the player.

8. The system of claim 4, wherein the second virtual environment display further displays a player camera feed; wherein the player camera feed displays video data from a camera that captures real-world video of a player of the virtual environment.

9. The system of claim 8, wherein the second virtual environment display enables selection, by the spectation administrator, of any of the first perspective, the second perspective, and the player camera feed as an overlay perspective; wherein the overlay perspective is overlaid on the selected perspective and displayed to the spectator; wherein the second virtual environment display indicates the overlay perspective to the spectation administrator.

10. The system of claim 3, wherein the second virtual environment display enables selection, by the spectation administrator, of the first perspective and the second perspective as an overlay perspective; wherein the overlay perspective is overlaid on the selected perspective and displayed to the spectator; wherein the second virtual environment display indicates the overlay perspective to the spectation administrator.

11. The system of claim 10, wherein the second virtual environment display enables scaling and moving, by the spectation administrator, of the overlay perspective relative to the selected perspective.

12. The system of claim 1, wherein the first virtual environment display further displays a second perspective of a virtual environment to a spectator; wherein the second perspective is overlaid and inset on the first perspective.

13. The system of claim 1, wherein the first virtual environment display further displays a player camera feed; wherein the player camera feed displays video data from a camera that captures real-world video of a player of the virtual environment; wherein the player camera feed is overlaid and inset on the first perspective.

14. The system of claim 13, wherein the second virtual environment display enables scaling and moving, by the spectator, of the player camera feed relative to the first perspective.

15. The system of claim 13, wherein the first virtual environment display further displays a chat interface that enables the spectator to textually chat with other spectators.

16. The system of claim 1, further comprising an avatar facial overlay system that captures real-world video data of a player of the virtual environment, generates mouth movement data from mouth movement of the player, and generates facial movements of an avatar in the virtual environment based on the mouth movement data; wherein the avatar corresponds to a player character controlled by the player.

17. The system of claim 16, wherein the real-world video data is captured by a camera mounted to a head-mounted display worn by the player.

18. The system of claim 1, further comprising an avatar facial overlay system that captures real-world video data of a player of the virtual environment, generates eye movement data from eye movement of the player, and generates eye movements of an avatar in the virtual environment based on the eye movement data; wherein the avatar corresponds to a player character controlled by the player.

19. The system of claim 18, wherein the real-world video data is captured by a camera mounted to a head-mounted display worn by the player.

20. A system for dynamic spectating includes:
a first virtual environment display that displays a first perspective of a virtual environment and a player camera feed to a spectator; wherein the player camera feed displays video data from a camera that captures real-world video of a player of the virtual environment; wherein the player camera feed is overlaid and inset on the first perspective;
a status overlay that displays information about an event occurring within the virtual environment;
a virtual camera manager that controls the position and orientation of the first perspective within the virtual environment; and
an avatar facial overlay system that generates mouth movement data from eye movement of the player and generates eye movements of an avatar in the virtual environment based on the eye movement data; wherein the eye movement of the player is captured by the player camera feed; wherein the avatar corresponds to a player character controlled by the player.
